(19) United States
(12) Patent Application Publication
(10) Pub. No.: US 2006/0092626 A1
(43) Pub. Date: May 4, 2006

(54) Vision improving apparatus and method

(76) Inventor: Daniel A. Hughes, Coatesville, PA (US)

Correspondence Address: ROBERT S. LIPTON, ESQUIRE, 201 NORTH JACKSON STREET, P. O. BOX 934, MEDIA, PA, 19063-0934, US

(21) Appl. No.: 10/978,229

(22) Filed: Oct. 29, 2004

(51) Int. Cl. F21V 33/00

(52) U.S. Cl. 362/109; 362/116; 362/230

(57) ABSTRACT

The Invention is an apparatus and method for improving near-vision visual acuity during reading by persons having hyperopia or presbyopia. The apparatus is a lamp projecting blue light from a light-emitting diode upon a reading material. The method comprises illuminating reading material with the lamp of the invention.

### BACKGROUND OF THE INVENTION

1. Field of the Invention

The Invention is an apparatus and method to allow a person having presbyopia or hyperopia to see more clearly while reading. The Invention relates to the discovery that illumination of an object in a person's near vision using light from a light-emitting diode emitting blue light improves the person's visual acuity and allows a person to see the object with greater clarity.

2. Description of the Related Art

Hyperopia is a visual condition in which images come to a focus behind the retina of the eye and visual acuity is better for distant than for near objects. The cause of hyperopia is generally regarded as a structural imperfection of the eye. Presybopia is a visual condition which becomes apparent in middle age and results in the inability to focus sharply for near vision. In presbyopia, as in hyperopia, the image comes to a focus behind the retina of the eye. The cause of presbyopia is less clear, but is frequently stated as a loss of elasticity of the lens of the eye preventing the eye from fully accommodating changing vision requirements.

Both hyperopia and presbyopia may be corrected by the wearing of corrective lenses, such as eyeglasses or contact lenses. While surgical treatments are available, many persons with either hyperopia or presbyopia are completely dependent on eyeglasses for ordinary tasks such as reading a menu.

### SUMMARY OF THE INVENTION

The Invention is based on the discovery that illumination of an object using light emitting diodes generating blue light improves the near vision visual acuity of a person, including a person having hyperopia or presbyopia. The apparatus of the Invention is a lamp utilizing light emitting diodes (LEDs) emitting blue light. The Invention also is a method of enhancing near vision using the lamp of the Invention.

To use the invention, a person will illuminate an object, such as a book or menu, using one or more light-emitting diodes that emit a generally blue light. The blue light-emitting diodes currently available utilize gallium nitride, indium gallium nitride or synthetic sapphire substrates and have a dominant wavelength of between about 445 and about 485 nanometers (“nm”). For purposes of this application, the term “dominant wavelength” means the wavelength of light corresponding to a color that an observer would select as matching the hue of the light emitted by the LED.

The use of the blue LED light will improve the visual acuity of the person attempting to read the book or menu. While the beneficial effect of the blue LED light varies among individuals, some persons who are otherwise dependent on corrective lenses for near vision may be able to read the book or menu without corrective lenses. For a person more affected by hyperopia or presbyopia, the Invention may improve the person's near vision while the person also uses corrective lenses.

The mechanism of operation of the Invention is not known fully. One possible explanation is that the blue light activates the rod light receptors in the eye as a function of the person's scotopic vision, causing the pupil of the eye to contract. The contraction of the pupil increases the depth of field perceived by the person to be in focus, just as reducing the aperture of a camera increases the camera's depth of field. The increase in depth of field reduces the effect of the focal point of the lens falling behind the retina of a person with hyperopia or presbyopia.

The lamp of the Invention generally supplements other light sources, preferably light sources of wavelengths longer than 485 nm and in the range of 485 nm to 680 nm. The Invention is most effective when attempting to read under low light conditions.

The Invention will improve the near-vision depth of field for all persons and for all tasks requiring a high degree of near-vision visual acuity; for example, the Invention is useful for a jewelry maker, machinist, or any person performing tasks requiring acute near vision where color perception is not critical and where ambient lighting conditions are less than optimal.

### BRIEF DESCRIPTION OF THE FIGURES

FIG. 1 is a perspective view of an embodiment of the lamp of the Invention.

FIG. 2 is a perspective view of the lamp of the Invention in use to read a menu.

FIG. 3 is an exploded perspective view of the embodiment shown by FIGS. 1 and 2.

FIG. 4 is a second embodiment of the lamp of the Invention disclosing a desk lamp.

FIG. 5 is a detail view of the second embodiment.

FIG. 6 is a third embodiment of the lamp of the Invention disclosing a lamp that clips onto reading material.

FIG. 7 is a detail view of the third embodiment.

### DESCRIPTION OF AN EMBODIMENT

FIGS. 1-3 illustrate a first embodiment of the apparatus of the Invention. The apparatus is a lamp 2. The lamp includes a light-emitting diode (LED) 4 selected to emit a generally blue light having a dominant wavelength of between about 445 nanometers (nm) and 485 nm. The perceived color of the light falls on a continuum. Light toward the middle of the wavelength range will appear bluer than light at the longer wavelength end of the range, which will appear greener. Light at the shorter end of the range of wavelengths will appear more violet than light from the middle of the range.

As shown by FIG. 1, the LED 4 is retained by a body 6. An electrical switch 8 selectively activates LED 4. The lamp 2 illustrated by FIGS. 1-3 is intended to be carried by a person having hyperopia or presbyopia and to be used whenever eyeglasses are unavailable or otherwise inconvenient. The body 6 of lamp 2 of FIG. 1 defines an opening 10. A first ring 12 passes through the opening and connects to a key ring 14 to which the person's keys may be affixed. The body 6 of lamp 2 of the first embodiment is compact and at approximately 1.75 inches in length is sized to fit in the person's pocket or purse for ease of transportation and use.

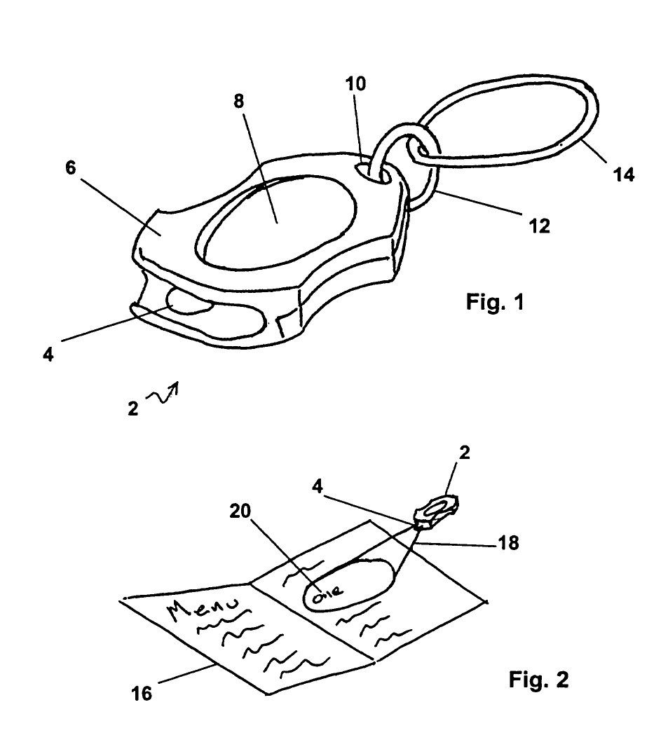

FIG. 2 shows the lamp 2 of the first embodiment in operation to read a reading material 16, in this case a menu in a restaurant. As used in this application, the term “reading material” 16 means any object or portion of an object upon which a letter, word, number or other indicia appears. A person grips the body 6 of lamp 2 and depresses switch 8, activating LED 4. LED 4 projects a beam 18 of generally blue light. The person directs the beam 18 of generally blue light against the reading material 16 while the reading material 16 is within the range of the person's near vision. For purposes of this application, the term “near vision” means a location within about three feet of an eye of the person. The person then observes the text 20 of the reading material 16 on which the beam 18 falls. For a person with hyperopia or presbyopia, the text 20 will appear sharper than text that is not so illuminated.

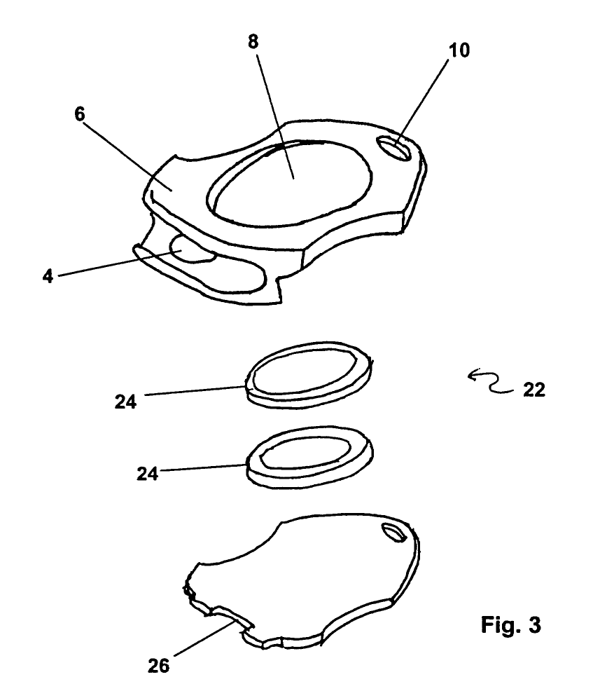

FIG. 3 is a perspective exploded view of the lamp 2 of the first embodiment showing the power supply 22 of the lamp 2. The power supply 22 of this embodiment includes two electrical cells 24 which are electrically connected to the switch 8 and to the LED 4. The two electrical cells 24 are retained in position by a base 26.

The beneficial effect of the beam 18 of generally blue light from LED 4 to illuminate reading material 16 varies from person to person and not all persons experience the beneficial effects. By use of the lamp 2 of the Invention, some persons who otherwise are dependent upon near-vision corrective lenses for reading are able to read without using the corrective lenses. The embodiment of FIGS. 1-3 is particularly useful as a portable reading aid to be attached to the person's key ring and available when the person is away from home.

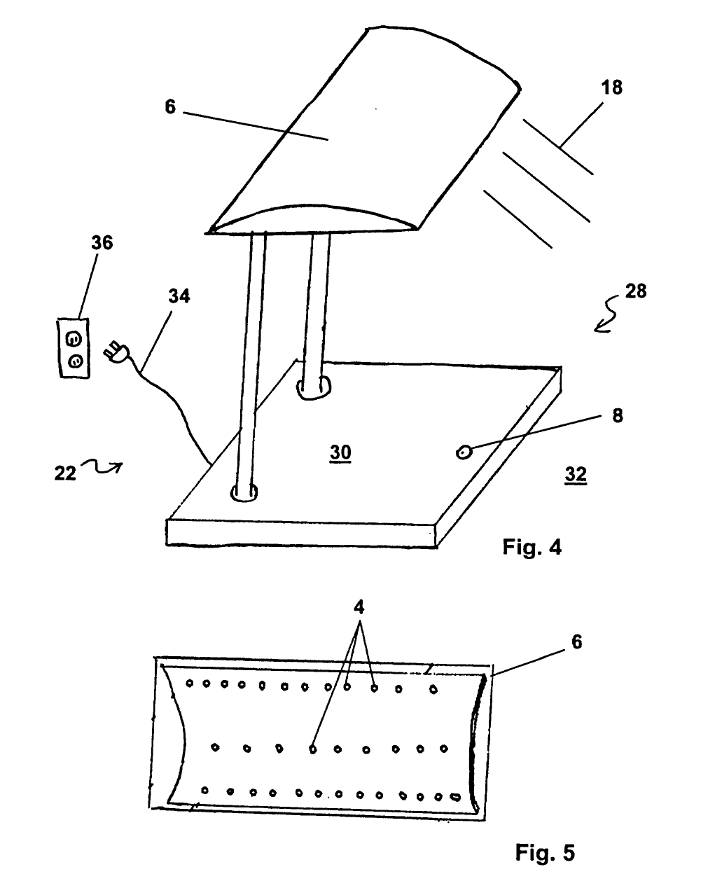

FIGS. 4 and 5 illustrate a desk lamp 28 embodiment of the Invention. As shown by FIG. 4, a base 30 rests upon a reading surface 32, such as a desk top. The base 30 supports a body 6. As shown by FIG. 5, which is a plan view of the underside of body 6, a plurality of LEDs 4 are mounted to the underside of body 6. As shown by FIG. 4, beams 18 of blue light from the LEDs are projected onto reading surface 32. A switch 8 mounted to base 30 selectably connects LEDs 4 to a power supply 22. In this instance, the power supply 22 is a power cord 34 adapted to be plugged into a wall outlet 36. Circuitry within base 8 or body 6 appropriately manipulates electrical power so that the power meets the operating parameters of LEDs 4.

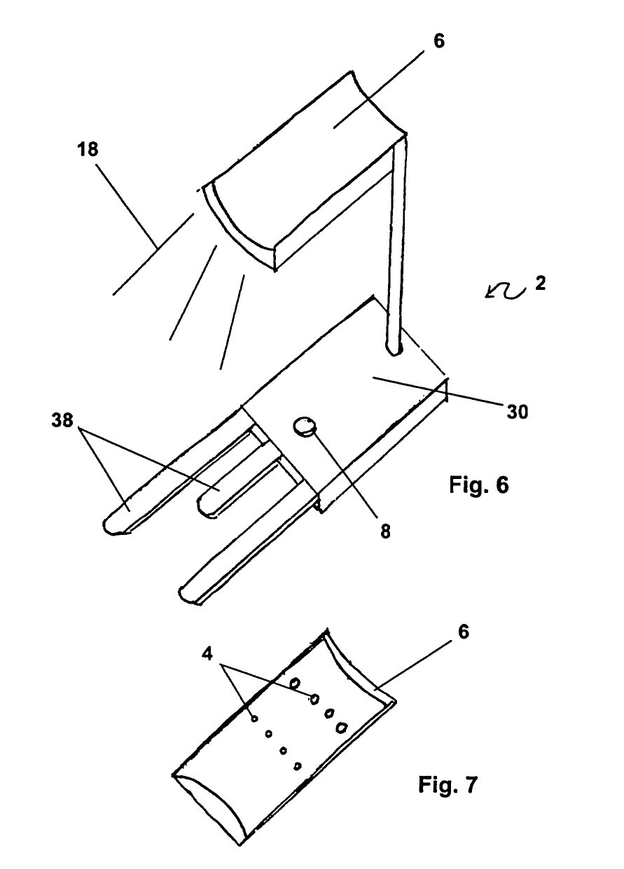

FIGS. 6 and 7 illustrate a third embodiment of the lamp 2. The lamp 2 shown by FIGS. 6 and 7 is adapted to be attached to the reading material 1 6, such as a book. Clips 38 attached to base 30 selectably engage the reading material 16, securing the lamp 2 in position. The clip 38 and base 30 are attached to body 6 and support body 6 in a pre-determined location with respect to reading material 16.

FIG. 7 is a plan view of the underside of body 6. As shown by FIG. 7, LEDs 4 are mounted to the underside of body 6. As shown by FIG. 6, a switch 8 selectably connects a power supply 22 contained within base 30 and the LEDs 4, activating the LEDs. When the lamp 2 is attached to the reading material 16 and the LEDs are activated, beam 18 of blue light from the LEDs 4 is projected on the text 20 of the reading material 16. Power supply 22 for this third embodiment may be electrical cells 24 enclosed within body 6. Alternatively, power supply 22 may include a power cord 34 attached to a wall socket 36.

In describing the above embodiments of the invention, specific terminology was selected for the sake of clarity. However, the invention is not intended to be limited to the specific terms so selected, and it is to be understood that each specific term includes all technical equivalents that operate in a similar manner to accomplish a similar purpose.

I claim:

1. An apparatus improving visual acuity during reading of a reading material by a person having hyperopia or presbyopia, the apparatus comprising:
a. a light-emitting diode, said light-emitting diode being constructed to emit a generally blue light, said light-emitting diode being configured to illuminate the reading material;
b. a body, said body being configured to retain said light-emitting diode;
c. an electrical power supply;
d. a switch selectably and operably connecting said light-emitting diode and said electrical power supply such that said switch selectably causes said power supply to energize said light emitting diode, thereby causing said light emitting diode to emit said generally blue light.

2. The apparatus of claim 1 wherein said light emitting diode is selected to emit said generally blue light having a dominant wavelength of between 445 nm and 485 nm.

3. The apparatus of claim 2 wherein said configuration of said body to retain said light emitting diode is such that the person may manually grip said body and direct said generally blue light toward the reading material, the reading material being located within a near vision of the person.

4. The apparatus of claim 3 wherein said power supply comprises an electrical cell.

5. The apparatus of claim 4 wherein said body defines an interior volume, said electrical cell is contained within said interior volume, said body being sized to fit within a pocket or a purse of the person.

6. The apparatus of claim 5 wherein said body defines an opening passing through said body, the apparatus further comprising: a key ring passing through said opening, said key ring being adapted to receive and retain a key.

7. The apparatus of claim 2, further comprising: a base, said base supporting said body.

8. The apparatus of claim 7, said base being adapted to support said body in a predetermined location with respect to the reading material, the reading material being within a near-vision of the person, said light-emitting diode being configured to illuminate the reading material when said body is in said pre-determined location.

9. The apparatus of claim 8 wherein said light emitting diode comprises a plurality of light-emitting diodes, each of said plurality of light-emitting diodes being selected to emit said generally blue light.

10. The apparatus of claim 2, the apparatus further comprising: a clip, said clip being adapted to releasably engage the reading material when the reading material is within a near-vision of the person, said clip supporting said body in a pre-determined location with respect to the reading material, said light-emitting diode being configured to illuminate the reading material when said body is in said pre-determined location.

11. A method of enhancing near-vision visual acuity during reading, the method comprising the steps of:
a. placing a reading material at a pre-determined reading location, said pre-determined reading material being located within the near-vision of a person;
b. illuminating said reading material with a generally blue light emitted by a light emitting diode.

12. The method of claim 11 wherein said generally blue light emitted by said light emitting diode exhibits a dominant wavelength of from 445 nm to 485 nm.

13. The method of claim 12 wherein said reading material is also illuminated with a second light source having a dominant wavelength of greater than 485 nm.

14. The method of claim 13 wherein said second light source has a dominant wavelength generally of between 485 nm and 680 nm.

15. The method of claim 14 wherein said step of illuminating said reading material with said generally blue light comprises said person manually manipulating a lamp body, said lamp body containing an electrical cell, a switch operably connected to said electrical cell and said light emitting diode operably connected to said switch and said electrical cell, said person directing a beam of said generally blue light to the reading material.

16. The method of claim 14 wherein said pre-determined reading location is located within a beam of said generally blue light emitted by said light emitting diode, said light emitting diode being mounted to a body, said body being supported by a base, said body, said base and said light emitting diode being adapted to selectably illuminate said reading material when said reading material is placed in said pre-determined location.

17. The method of claim 13 wherein said step of illuminating said reading material with said generally blue light comprises releasably attaching a clip to the reading material, said clip supporting a body, said body supporting said light-emitting diode, said light emitting diode directing said generally blue light toward said reading material.
